(19) United States
(12) Patent Application Publication
(10) Pub. No.: US 2022/0126703 A1
(43) Pub. Date: Apr. 28, 2022

(54) METHOD FOR ASSISTING A DRIVER OF A VEHICLE HAVING AN ELECTRIC DRIVE

(71) Applicant: Robert Bosch GmbH, Stuttgart (DE)

(72) Inventors: Florian Stratz, Hemmingen (DE); Ralph Goll, Hemmingen (DE); Thomas Matschke, Bietigheim-Bissingen (DE)

(21) Appl. No.: 17/429,810

(22) PCT Filed: Feb. 5, 2020
(86) PCT No.: PCT/EP2020/052821

§ 371 Date: Aug. 10, 2021

(30) Foreign Application Priority Data
Feb. 14, 2019 (DE) 10 2019 201 955.2

(51) Int. Cl. B60L 15/20; B60W 50/14; B60W 30/14

(52) U.S. Cl. CPC B60L 15/2045; B60W 50/14; B60W 30/143; B60W 2540/30; B60W 2540/215; B60W 2530/16; B60W 2050/0026; B60W 2520/10; B60W 2520/12; B60W 2720/10; B60W 2720/12; B60W 2510/244; B60W 2530/20

(57) ABSTRACT

The invention relates to a method for assisting a driver of a vehicle (1) having an electric drive, in which a list of predefined influencing variables for the consumption of electrical energy by the vehicle (1) is drawn up and output by an output device (14), with the influencing variables relating to factors which can be influenced by the driver of the vehicle (1), the method comprising the following steps: a) calling up characteristic maps which specify a relationship between energy consumption and the various influencing variables, b) determining possible optimizations of the energy consumption by modifying a particular influencing variable, c) computing possible energy savings on implementation of the possible optimizations of the particular influencing variable using the characteristic maps retrieved, d) sorting the influencing variables in the list.

### BACKGROUND OF THE INVENTION

The invention relates to a method for assisting a driver of a vehicle having an electric drive, wherein the consumption of electrical energy by the vehicle is determined by influencing variables, and wherein the influencing variables relate to factors, which are influenceable by the driver of the vehicle. Moreover, the invention relates to a driver assistance system, which is configured for carrying out the method.

Electric vehicles and hybrid vehicles include an electrical energy store, for example, a battery, which provides energy for operating an electric drive. As a result, a range of the electric vehicle and/or a range of a hybrid vehicle that can be covered electrically is determined from the remaining capacity of the energy store and from the future energy demand of the vehicle. In known energy stores, in particular batteries, the storage capacity is limited, and so electric vehicles and hybrid vehicles have only a limited range that they can cover by utilizing the electric drive. This is problematic, since a resultant “range anxiety” represents a considerable barrier to the acceptance of electromobility.

It is known from the related art to extrapolate a remaining range from the past current consumption and from the present capacity of the energy store. DE 10 2018 104 999 A1 describes a consumption management for extending the range of an electric vehicle. In one variant, it is provided to predefine a target range extension and, on the basis thereof, determine compromises for the control, such as, for example, a reduced operating speed or a reduction of additional consumers. Thereafter, the vehicle systems are operated according to these compromises, in order to achieve the required range. In a second variant of the method, while the vehicle is in motion, multiple reduced performance levels are calculated under consideration of previously determined compromises, which can be accepted by a driver of the vehicle. Upon acceptance by the user, the controller then operates the drive according to the compromises. In a third variant of the travel, the user selects attributes for a reduced mode already in advance, such as, for example, heating, cooling, acceleration, and maximum speed. The controller can then output a range for each mode.

The disadvantage of the related art is that the effects that the variables actually influenceable by the driver have on the electric range, such as the speed of the vehicle, the heating, the air conditioning, the opening or closing of windows, and the operation of further consumers, are not readily apparent to the driver. In order to improve the acceptance of electrically driven vehicles and reduce the “range anxiety”, it would be meaningful, however, to directly show the driver the consequences of the influencing variables determinable by him/her on the range.

### SUMMARY OF THE INVENTION

The invention relates to a method for assisting a driver of a vehicle having an electric drive, in which a list of predefined influencing variables for the consumption of electrical energy by the vehicle is created and output by an output device. The influencing variables relate to factors, which are influenceable by the driver of the vehicle. The method includes, in a first step a), retrieving characteristic maps, which describe a relationship between an energy consumption and the particular influencing variable. In a further step b) of the method, possible optimizations of the energy consumption are determined by modifying the particular influencing variable. In a subsequent step c) of the method, energy savings are calculated, which are possible due to implementing the possible optimizations of the particular influencing variables, wherein the retrieved characteristic maps are utilized. In a subsequent step d) of the method, a sorting of the influencing variables in the list takes place. The influencing variables are preferably sorted according to the extent of the particular possible energy savings. For example, influencing variables having higher energy savings are listed first.

The method is applicable on any type of electric vehicle. In a fully electric vehicle, the driver receives recommendations regarding how he/she can optimize the overall possible range of his/her vehicle. In a hybrid vehicle or a plug-in hybrid vehicle, the driver can receive, in particular, recommendations regarding how he/she can optimize the range of his/her vehicle coverable solely by utilizing the electric drive.

The steps a), b), and c) of the method are preferably carried out for each of the influencing variables. It is conceivable that the quantity of influencing variables included in the list is fixedly predefined or is determined in advance via a selection made by the driver.

The influencing variables are each related to factors, which are influenceable by the driver of the vehicle. The influencing variables include, for example, a predefined speed, for example, by specification to a vehicle-speed controller, the driving style, i.e., whether the driver drives in a sporty or economical manner, the setting of the heating, the setting an air conditioning system, the selection of the tires of the vehicle, the attachment or removal of accessories such as roof racks or rear-mounted luggage racks, the set tire pressure, the utilization of further electric consumers such as, for example, an infotainment system, a seat heater, or a window heater, and the opening condition of windows or of a sunroof.

The characteristic maps retrieved in the step a) of the method indicate a relationship with the energy consumption for the individual conditions or values that an influencing variable can assume. For example, the characteristic map for the parameter speed can indicate the average energy consumption of the vehicle at various speeds. In the case of additional electric consumers such as, for example, a window heater, the relevant characteristic map can indicate the energy consumption when window heating is activated and when window heating is deactivated. Moreover, the characteristic maps can be designed to be multi-dimensional, for example, when the energy consumption of an influencing variable is dependent on further parameters such as, for example, the present surroundings conditions. In this way, it can be indicated, for example, for a heating, how much energy is necessary to maintain a certain interior temperature for various exterior temperatures.

In the step B) of the method, possible optimizations of the energy consumption are determined for the individual influencing variables. If only one of two possible conditions are assumable for an influencing variable, for example, a roof rack can be present or has been removed, the particular more favorable condition is determined as the possible optimization. If various discrete conditions are possible, for example, stages for a seat heating or window heating, appropriate optimizations can be determined for each of the possible conditions that the influencing variable can assume. If an influencing variable can be continuously varied, for example, the speed or a steplessly adjustable heating, the possible optimizations can be determined, in the step b), to be reductions in multiple steps, such as, for example, a reduction by 10% or in certain multiples of the particular unit of the influencing variable. In this way, for example, with respect to the speed, the optimization for reducing the speed can be indicated in steps of 10 km/h and, with respect to the heating, the optimization for reducing the temperature can be indicated in steps of 1° C. Preferably, the possible optimizations are determined under consideration of and/or starting from the present condition of the particular influencing variable. It can be provided to detect the present condition of an influencing variable automatically, for example, via sensors.

In the step c) of the method, possible energy savings are determined for the previously determined optimization possibilities of the individual influencing variables by utilizing the characteristic maps. If multiple possible optimizations were determined for an influencing variable, the possible energy savings for all determined optimization possibilities are preferably calculated in step c). In the simplest case, the calculation can be read out by simply looking up, in the characteristic map, the energy consumption for an influencing variable for the particular condition determined by the optimizations.

In the step d) of the method, a sorting of the influencing variables in the list takes place. If multiple optimizations are possible for the particular influencing variables, multiple optimizations are also preferably taken into account, and so, if necessary, a single influencing variable can also appear in the list multiple times. Alternatively, it is possible, for each of the influencing variables, to select one of the possible optimizations and utilize it for the sorting of the list. The selected optimization can be selected, for example, as the smallest modification of the particular influencing variable or the optimization can be determined that allows for the greatest energy savings.

After the sorting of the influencing variables according to step d), the output of the list takes place by utilizing the output device. In particular, it can be determined that, together with the naming of an influencing variable in the list, the achievable energy savings, together with the particular entry for the influencing variable, are displayed or output in each case.

Preferably, on the basis of the possible energy savings for each influencing variable, it is determined how much range can be obtained by carrying out the particular optimization of the influencing variable and the determined obtainable range is output together with the list. An output of the obtainable range is advantageous, since a range gain is more easily understood by a driver than the possible energy savings.

This variant of the method represents a range mode, which indicates to the driver, by means of which of the influenceable influencing variables the range of the vehicle can be extended, wherein the driver receives recommendations, which are preferably sorted according to the extent of the optimization potential and/or the size of the possible range extension.

Preferably, in the method, a destination is predefined by the driver and the specification is made that the distance to the destination must be covered by the vehicle without recharging an energy store of the vehicle, wherein, under consideration of the influencing variables and the characteristic maps, a speed specification is determined which enables the destination to be reached without recharging and wherein this speed specification is output together with the list.

This variant of the method represents a destination mode, which assists the driver of a vehicle to reach a selected destination as quickly as possible without a charging pause.

In a preferred variant of the destination mode, it is provided in the method that it is determined, from the possible energy savings, for each influencing variable, by what extent the speed specification can be increased by carrying out the particular optimization of the influencing variable, and the determined increase is output together with the list in each case.

In a further embodiment of the destination mode, it is provided that the speed specification is transmitted to a vehicle-speed controller of the vehicle. If an energy savings is carried out by the driver by implementing one of the possible optimizations of one of the influencing variables, the speed specification is appropriately updated and transmitted to the vehicle-speed controller.

Preferably, the influencing variables are selected from parameters influencing the aerodynamic drag of the vehicle, parameters influencing the rolling resistance of the vehicle, the speed of the vehicle, the driving style of the driver, parameters related to the air conditioning and/or the heating of the vehicle, parameters related to the condition of further electrical consumers of the vehicle, and combinations of several of these parameters. The further electrical consumers include, for example, an infotainment system.

The parameters influencing the aerodynamic drag of the vehicle are selected, in particular, from the opening condition of vehicle windows, the opening condition of a sun roof, the presence of a roof rack and/or a rear-mounted luggage rack, and combinations of several of these parameters. It can be provided, in particular, that these parameters are queried via appropriate sensors in an automated manner by means of the method. For example, the opening condition of a window or of a sun roof can be determined via appropriate sensors, or the presence of a rear-mounted luggage rack or a roof rack can be detected via a sensor.

The aerodynamic drag of the vehicle is influenced by the opening of vehicle windows or a sun roof as well as by the presence of accessories such as a roof rack or a rear-mounted luggage rack. The energy savings achievable due to the implementation of a more favorable condition, for example, by closing a window or removing a roof rack, are also dependent, in particular, on the instantaneous vehicle speed, and so this is taken into account preferably by providing an appropriate dimension in the characteristic map.

Preferably, the parameters influencing the rolling resistance of the vehicle are selected from the type of tires and/or the air pressure of the tires of the vehicle. Preferably, these parameters are determined in an automated manner within the scope of the method. The air pressure can be detected via a tire pressure sensor and the type of the tire can be determined, for example, by reading out an identification code of the tire pressure sensor.

Preferably, the parameters related to the air conditioning and/or the heating of the vehicle are selected from the set setpoint temperature for heating and/or air conditioning, the operating condition of a seat heating, the operating condition of a window heating, and combinations of several of these parameters. These parameters are preferably queried in an automated manner via communication with the appropriate operating elements of the vehicle. Moreover, it is preferred that the ambient temperature is determined via a thermometer, since, for the air conditioning or heating of a vehicle, the instantaneous external temperature is relevant for the determination of the energy consumption. Preferably, in addition, the external temperature is taken into account by providing an appropriate dimension in the characteristic map.

Parameters such as, for example, the speed of the vehicle or the driving style of the driver, are preferably automatically detected via appropriate sensors within the scope of the method. For example, the driving style of the driver can be determined via evaluation by sensors, which detect the longitudinal and transverse acceleration of the vehicle. When strong accelerations occur, a sporty driving style is inferred, which requires a higher energy consumption, and, when slower accelerations occur, an economic driving style is inferred.

When the method is applied, a list is created, which is preferably sorted from large effect to small effect. For example, such a list can list the following variables and their effects:
vehicle-speed controller speed from 100 km/h to 90 km/h yields −3 kW and results in a range extension of 22 km,
driving style from sporty to economical yields −2 kW and results in a range extension of 15 km,
heating from presently 22° to 18° yields −1.5 kW and results in a range extension of 11 km,
using summer tires instead of winter tires yields −1.5 kW and results in a range extension of 11 km,
air conditioning system from presently 20° to 23° yields −1 kW and results in a range extension of 7 km,
removing the roof rack yields −1 kW and results in a range extension of 7 km,
increasing tire pressure by 0.5 bar yields −1 kW and results in a range extension of 7 km, closing the sun roof (reducing tractional resistance) yields −1 kW and results in a range extension of 4 km,
switching off the infotainment yields −0.5 kW and results in a range extension of 4 km,
switching off the seat heating yields −0.5 kW and results in a range extension of 4 km,
switching off the window heating yields −0.5 kW and results in a range extension of 4 km,
closing the windows (reducing tractional resistance) yields −0.5 kW and results in a range extension of 4 km.

Correspondingly, recommendations can also be created, which allow for an increase of the speed, wherein the destination can nevertheless be reached without a charging pause. For example, the list can include recommendations to completely switch off the heating, as the result of which a speed increase for the vehicle-speed controller from 95 km/h to 100 km/h is made possible.

The influencing variables mentioned in these examples, possible optimizations and their effects on energy consumption and range represent only one possible example in each case. In particular, the achievable effects vary according to the vehicle.

Preferably, the characteristic maps are retrieved from a vehicle-external unit or from a memory of a control unit assigned to the vehicle.

The vehicle-external unit can be, in particular, a server or a cloud server, which is reachable via a communication network such as a mobile radio link or the Internet. The vehicle can then contain, in particular, means for wirelessly communicating with this vehicle-external unit.

In the method, it is preferably provided that, after the implementation of an optimization for an influencing variable, the actual energy savings are determined and transmitted to the vehicle-external unit or stored in the control unit, wherein an updating of the characteristic maps is carried out for this influencing variable according to the actual energy savings. This makes it possible to train aging effects on components of the vehicle, such as, for example, the engine, the heating, the air-conditioning compressor, the tire, etc., with respect to the energy consumption and correctly take these into account in the sorting of the list.

The characteristic maps for the individual influencing variables stored in the vehicle-external unit and/or in a memory of the control unit assigned to the vehicle are, in particular, multi-dimensional characteristic maps, in order to take the relationship of the energy consumption into account for all operating conditions and, if necessary, for various surroundings conditions such a vehicle speed or external temperature.

For example, in the case of the vehicle temperature, a gradient AP/AT is stored in a characteristic map. AP is a difference with respect to energy consumption and AT is a difference with respect to temperature. On the basis of this gradient, it is possible to calculate how much electrical power is saved when the temperature is reduced. If the external temperature is, for example, 0° C. and the temperature drops from 20° C. to, for example, 18° C., the power to be saved, at a gradient of 0.25 kW per ° C., is 0.5 kW.

In the case of influencing variables related to the aerodynamic drag of the vehicle, it is to be taken into account that the aerodynamic drag increases quadratically with the speed and is dependent on vehicle-specific parameters such as the CW value and the end face. The speed at which a certain aerodynamic drag results is therefore preferably stored in a characteristic map, and, on the basis thereof, the power necessary for overcoming the aerodynamic drag is derived. If, for example, 10 kW power is needed at a speed of 90 km/h and 13 kW power is needed at 100 km/h, a power reduction of 3 kW can be achieved by reducing the speed from 100 km/h to 90 km/h.

The aerodynamic drag of the vehicle is also dependent on the opening condition of the windows. When a window is open, an eddy arises in the form of a turbulent flow, which changes the drag coefficient (cw) of the vehicle. The corresponding cw value for various conditions of the windows at various speeds of the vehicle is preferably stored in a characteristic map. If, for example, 10 kW power is needed at 90 km/h and with the windows closed, and 10.5 kW is needed at the same speed with the windows completely open, an optimization by closing the windows results in a power reduction of 0.5 kW.

A further aspect of the invention is to provide a driver assistance system for assisting a driver of a vehicle having an electric drive. The driver assistance system includes an output device for outputting a list of influencing variables for the consumption of electrical energy by the vehicle and a control unit, which is configured for carrying out one of the methods described herein.

The driver assistance system is designed and configured for carrying out the methods described herein, and so features described within the scope of the methods apply similarly for the driver assistance system and, conversely, features described in connection with the driver assistance system apply for the methods.

The control unit of the driver assistance system is preferably configured for communicating with sensors and other assistance systems of the vehicle, in order to obtain information regarding the instantaneous condition of the influencing variables.

The output device is preferably designed as a screen. Alternatively or additionally, the output device can also be designed as a loudspeaker, which acoustically outputs the list, for example, via a voice output. It is also alternatively or additionally possible to design the output device as a connection to a smart device of the driver, such as, for example, a smartphone or a tablet. In this case, for example, a screen or a loudspeaker of the smart device is utilized for outputting the list.

Due to the provided method, the acceptance of electrically driven vehicles is considerably increased, since the “range anxiety” is reduced due to the driver being better informed. As a further contribution to this increase in acceptance, possible optimizations are not automatically implemented, and so, in particular, the electric vehicle is not permanently operated in a reduced “eco mode”, in which the driving performance is reduced. In the provided method, the driver has the freedom to decide at any time, which of the influence factors he/she would like to influence, while, in a typical “eco mode”, a bundle of measures is simultaneously implemented, wherein, for example, the engine output is reduced, the speed is limited, and the utilization of the air conditioning system is reduced.

Advantageously, the influenceable influencing variables are output in the order of their saving potential, and so the driver can make an informed decision. In advantageous variants of the method, the driver can utilize this information in order to extend the range, as necessary, by implementing appropriate measures and, alternatively, the driver can utilize the possible energy savings in order to select the highest possible speed that enables a certain destination to be reached without a charging pause and, in this way, shorten his/her travel time.

### BRIEF DESCRIPTION OF THE DRAWINGS

Embodiments of the invention are described in greater detail with reference to the drawing and the following description.

The sole FIGURE shows a vehicle having a driver assistance system.

The FIGURE schematically represents the subject matter of the invention.

### DETAILED DESCRIPTION

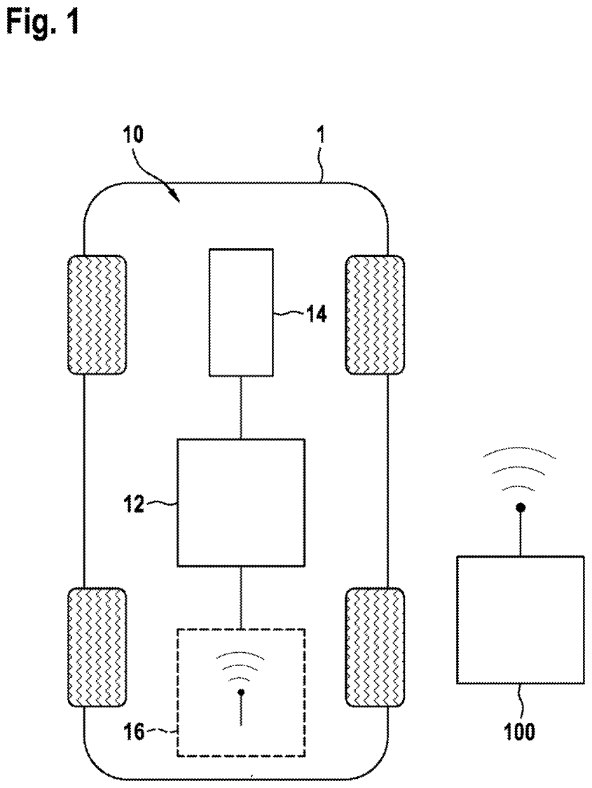

FIG. 1 shows a vehicle 1 with a driver assistance system 10 for assisting a driver of a vehicle 1. The vehicle 1 includes an electric drive and, thereby, is designed, for example, as an electric vehicle or as a hybrid vehicle.

The driver assistance system 10 includes a control unit 12 and an output device 14.

By means of the driver assistance system 10, characteristic maps, which indicate a relationship between energy consumption and the particular influencing variable, are retrieved for various influencing variables, which are influenceable by the driver and each influence the consumption of electrical energy by the vehicle 1. These characteristic maps can be stored in a memory of the control unit 12. Alternatively or additionally, means for communication 16 can be provided, via which the driver assistance system 10 can communicate with a vehicle-external unit 100. The vehicle-external unit 100 is configured, for example, as a cloud server and, in this embodiment, provides the characteristic maps to the driver assistance system 10. Thereafter, the control unit 12 of the driver assistance system 10 determines possible optimizations of the energy consumption by modifying the particular influencing variable. Thereafter, a calculation is carried out to determine which possible energy savings can be achieved when the possible optimizations of the particular influencing variable are implemented. The control unit 12 utilizes the retrieved characteristic maps for this purpose. After the possible energy savings are calculated, the influencing variables are sorted and output in the form of a list. The output device 14 is utilized for this purpose. This is designed, for example, as a screen.

The invention is not limited to the exemplary embodiments described here and to the aspects emphasized therein. A multitude of modifications which are within the capabilities of those skilled in the art may rather be possible within the scope described by the claims.

1. A method for assisting a driver of a vehicle (1) having an electric drive, in which a list of predefined influencing variables for the consumption of electrical energy by the vehicle (1) is created and output by an output device (14), wherein the influencing variables relate to factors, which are influenceable by the driver of the vehicle (1), wherein the method includes the following steps:
a) retrieving characteristic maps, which indicate a relationship between energy consumption and at least one of the influencing variables,
b) determining possible optimizations of the energy consumption by modifying the at least one of the influencing variables,
c) calculating possible energy savings by implementing the possible optimizations of the at least one of the influencing variables by utilizing the retrieved characteristic maps,
d) sorting the influencing variables in the list.

2. The method as claimed in claim 1, wherein, on the basis of the possible energy savings for each influencing variable, it is determined how much range can be obtained by carrying out an optimization of the influencing variable and the determined obtainable range is output together with the list.

3. The method as claimed in claim 1, wherein destination is predefined and it is specified that the distance to the destination must be covered by the vehicle (1) without recharging an energy store of the vehicle (1), wherein, under consideration of the influencing variables and the characteristic maps, a speed specification is determined which enables the destination to be reached without recharging, and this speed specification is output together with the list in each case.

4. The method as claimed in claim 3, wherein, on the basis of the possible energy savings for each influencing variable, it is determined, by what extent the speed specification can be increased by carrying out an optimization of the influencing variable and the determined increase is output together with the list in each case.

5. The method as claimed in claim 3, wherein a speed specification is transmitted to a vehicle-speed controller of the vehicle (1).

6. The method as claimed in claim 1, wherein the influencing variables are selected from parameters influencing the aerodynamic drag of the vehicle (1), parameters influencing the rolling resistance of the vehicle (1), the speed of the vehicle (1), the driving style of the driver, parameters related to the air conditioning and/or the heating of the vehicle (1), parameters related to the condition of further electrical consumers in the vehicle (1), and combinations of several of these parameters.

7. The method as claimed in claim 6, wherein the parameters influencing the aerodynamic drag of the vehicle (1) are selected from the opening condition of vehicle windows, the opening condition of a sun roof, the presence of a roof rack and/or a rear-mounted luggage rack, and combinations of several of these parameters.

8. The method as claimed in claim 6, wherein parameters influencing the rolling resistance of the vehicle (1) are selected from the type of tires and/or the air pressure of the tires of the vehicle (1).

9. The method as claimed in claim 6, wherein the parameters related to the air conditioning and/or the heating of the vehicle (1) are selected from the set setpoint temperature for heating and/or air conditioning, the operating condition of a seat heating, the operating condition of a window heating, and combinations of several of these parameters.

10. The method as claimed in claim 1, wherein the characteristic maps are retrieved from a vehicle-external unit (100) or from a memory of a control unit (12) assigned to the vehicle (1).

11. The method as claimed in claim 10, wherein, after the implementation of an optimization for an influencing variable, the actual energy savings are determined and transmitted to the vehicle-external unit (100) or stored in the control unit (12), and an updating of the characteristic maps is carried out for this influencing variable according to the actual energy savings.

12. A driver assistance system (10) for assisting a driver of a vehicle (1) having an electric drive, including an output device (14) for outputting a list of influencing variables for the consumption of electrical energy of the vehicle (1), and a control unit (12), which is configured for carrying out the method as claimed in claim 1.
